(19) United States
(12) Patent Application Publication
(10) Pub. No.: US 2017/0061958 A1
(43) Pub. Date: Mar. 2, 2017

(54) METHOD AND APPARATUS FOR IMPROVING A NEURAL NETWORK LANGUAGE MODEL, AND SPEECH RECOGNITION METHOD AND APPARATUS

(71) Applicant: Kabushiki Kaisha Toshiba, Tokyo (JP)

(72) Inventors: Pei DING, Beijing (CN); Kun YONG, Beijing (CN); Huifeng ZHU, Beijing (CN); Jie HAO, Beijing (CN)

(73) Assignee: Kabushiki Kaisha Toshiba, Tokyo (JP)

(21) Appl. No.: 15/247,589

(22) Filed: Aug. 25, 2016

(30) Foreign Application Priority Data
Aug. 28, 2015 (CN) 201510543232.6

(51) Int. Cl. G10L 15/06; G10L 15/18; G10L 15/01; G10L 15/16

(52) U.S. Cl. CPC G10L 15/063; G10L 15/16; G10L 15/1822; G10L 15/1815; G10L 15/01; G10L 2015/0635

(57) ABSTRACT

According to one embodiment, an apparatus for improving a neural network language model of a speech recognition system includes a word classifying unit, a language model training unit and a vector incorporating unit. The word classifying unit classifies words in a lexicon of the speech recognition system. The language model training unit trains a class-based language model based on the classified result. The vector incorporating unit incorporates an output vector of the class-based language model into a position index vector of the neural network language model and use the incorporated vector as an input vector of the neural network language model.

### CROSS-REFERENCE TO RELATED APPLICATION

This application is based upon and claims the benefit of priority from Chinese Patent Application No. 201510543232.6, filed on Aug. 28, 2015; the entire contents of which are incorporated herein by reference.

### FIELD

The present invention relates to a method for improving a neural network language model of a speech recognition system, an apparatus for improving a neural network language model of the speech recognition system, and a speech recognition method and a speech recognition apparatus.

### BACKGROUND

A speech recognition system commonly includes acoustic model (AM) and language model (LM). Acoustic model is a model that summarizes probability distribution of acoustic feature relative to phoneme units, while language model is a model that summarizes occurrence probability of words sequences (word context), and speech recognition process is to obtain result with the highest score from weighted sum of probability scores of the two models.

As the most representative method in a language model, statistical back-off language model (e.g. ARPA LM) is used in almost all speech recognition systems. Such model is a discrete nonparametric model, i.e. directly summarizes the word sequence probabilities from their frequency.

In recent years, neural network language model (NN LM), as a novel method, has been introduced into speech recognition systems and greatly improves the recognition performance, wherein, deep neural network (DNN LM) and recurrent neural network (RNN LM) are the two most representative technologies.

The neural network language model is a parametric statistical model, and uses position index vector as word feature to quantify words of recognition systems. Such word feature is the input of neural network language model, and the outputs are the occurrence probabilities of each word in system lexicon as a next word given a certain word sequence history. The feature for each word is the position index vector, i.e. in a vector with the dimension of speech recognition system lexicon size, the value of the corresponding word position element is “1” and others are “0”.

### BRIEF DESCRIPTION OF THE DRAWINGS

FIG. 1 is a flowchart of a method for improving a neural network language model of a speech recognition system according to one embodiment of the invention.

FIG. 2 is a block diagram that illustrates the method for improving a neural network language model of a speech recognition system according to one embodiment of the invention.

FIG. 3 is a block diagram that illustrates the method for improving a neural network language model of a speech recognition system according to one embodiment of the invention.

FIG. 4 is a flowchart of a speech recognition method according to another embodiment of the invention.

FIG. 5 is a block diagram of an apparatus for improving a neural network language model of a speech recognition system according to another embodiment of the invention.

FIG. 6 is a block diagram of a speech recognition apparatus according to another embodiment of the invention.

### DETAILED DESCRIPTION

According to one embodiment, an apparatus for improving a neural network language model of a speech recognition system includes a word classifying unit, a language model training unit, and a vector incorporating unit. The word classifying unit classifies words in a lexicon of the speech recognition system. The language model training unit trains a class-based language model based on the classified result. The vector incorporating unit incorporates an output vector of the class-based language model into a position index vector of the neural network language model and use the incorporated vector as an input vector of the neural network language model.

Below, the embodiments of the invention will be described in detail with reference to drawings.

A Method for Improving a Neural Network Language Model of a Speech Recognition System

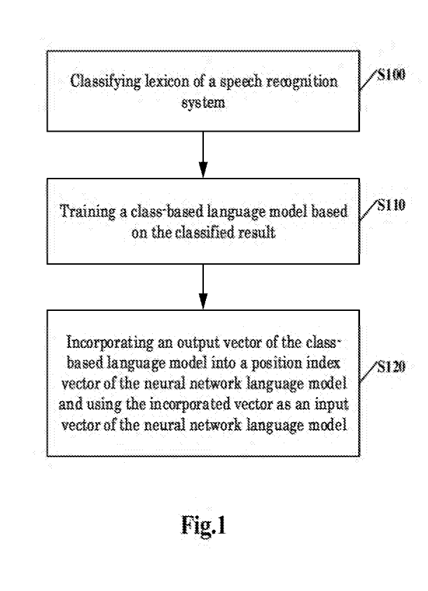

FIG. 1 is a flowchart of a method for improving a neural network language model of a speech recognition system according to the invention.

As shown in FIG. 1, first, in step S100, words in a lexicon of the speech recognition system are classified.

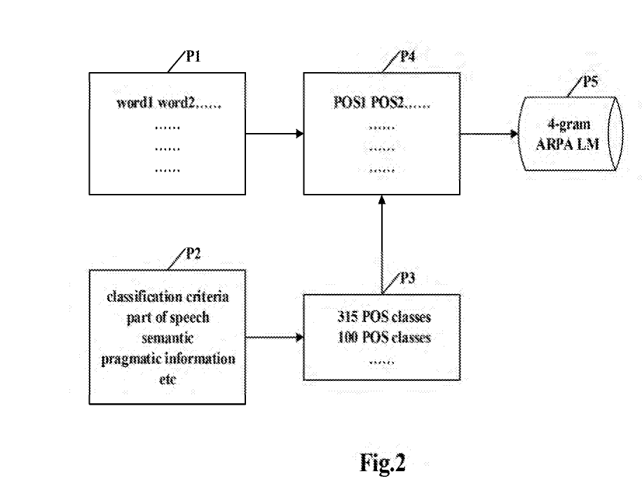

As to the method for classifying words in a lexicon of a speech recognition system, reference may be made to the description on the block diagram of FIG. 2.

In FIG. 2, P1 shows word1, word2 . . . in the lexicon.

As shown in P2, as criteria for classifying words in a lexicon of a speech recognition system, part of speech, semantic and pragmatic information etc. may be listed, and the embodiment has no limitation thereto. In the present embodiment, the description is made by taking part of speech as an example.

There are also different classification strategies when classifying words in a lexicon by using a same classification criterion, for example, as shown by P3 in FIG. 2, when words in a lexicon are classified by taking part of speech as criterion as in the present embodiment, there are classification that has 315 POS classes and classification that has 100 POS classes.

In the present embodiment, the description is made by taking the classification strategy that has 315 POS classes as an example.

When a strategy for classifying words in a lexicon has been determined, word1, word2 . . . in P1 will be classified into POS1, POS2 . . . in P4 corresponding to the 315 POS classes, so as to finish classification of words in the lexicon.

In addition, the criterion for classifying words in a lexicon of a speech recognition system is not limited to the above listed criteria, and any criterion may correspond to different classification strategies.

Returning to FIG. 1, the method proceeds to step S110 after words in a lexicon of the speech recognition system have been classified in step S100.

In step S110, a class-based language model is trained based on the classified result.

The step of training a class-based language model, based on the classified result is described with reference to FIG. 2.

When a class-based language model is trained based on the classified result in P4, the class-based language model may be trained by different n-gram levels, for example, a 3-gram language model, a 4-gram language model etc. may be trained. Besides, as type of the trained language model, ARPA language model, DNN language model, RNN language model and RF (random field) language model may be listed, for example, or it may be other language model.

As shown in P5 of FIG. 2, in the present embodiment, a 4-gram ARPA language model is taken as an example and it is taken as the class-based language model.

Returning to FIG. 1, the method proceeds to step S120 after the class-based language model has been trained based on the classified result in step S110.

In step S120, an output vector of the class-based language model is incorporated into a position index vector of the neural network language model and the incorporated vector is used as an input vector of the neural network language model.

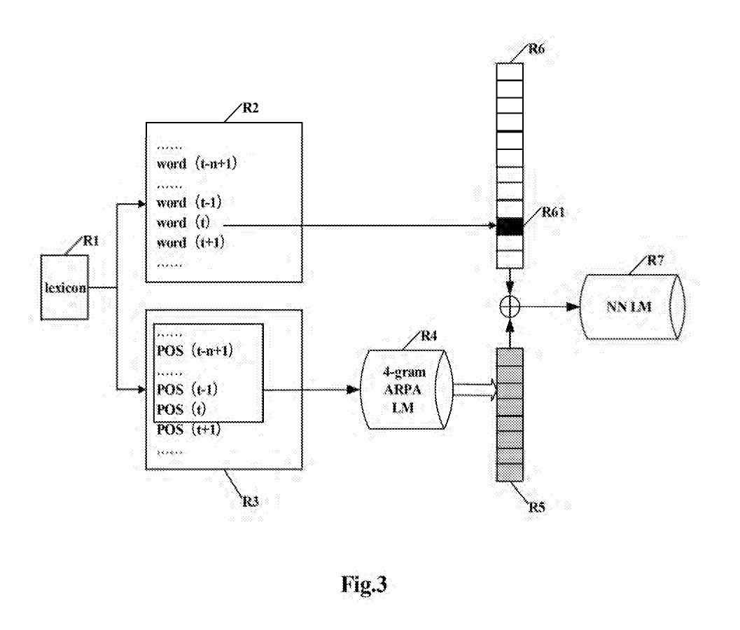

Next, referring to the block diagram of FIG. 3, an example of the processing of S120 will be described, and in FIG. 3, description is made by taking the position index vector corresponding to word(t) and the output vector of the class-based language model for example.

R1 represents a lexicon, and in the present embodiment, the lexicon R1 contains, for example, 10000 words.

As shown by R2 and R3, the 10000 words ‘ . . . word(t·n+1) . . . word(t−1)word(t)word(t+1) . . . ’ in the lexicon are classified in 315 POS classes, and ‘ . . . POS(t·n+1) . . . POS(t−1)POS(t)POS(t+1) . . . ’ in corresponding R3 are obtained.

The 4-gram ARPA language model in R4 is the class-based language model trained in the above S110, which takes 315 POS classes as the classification strategy. R6 represents the position index vector.

Next, referring to FIG. 3, the position index vector is described by taking the position index vector R6 for example.

A position index vector is feature of each word of a conventional neural network language model, its dimension is the same as the number of words in a lexicon, corresponding word position element is labeled as “1” and others are labeled as “0” in the lexicon. Thus, the position index vector contains position information of words in the lexicon.

In the present embodiment, the lexicon R1 contains 10000 words, so dimension of the position index vector R6 is 10000, in FIG. 3, each cell in R6 represents one dimension, and only a portion of dimensions is shown in FIG. 3.

The black solid cell R61 in the position index vector R6 corresponds to position of word in the lexicon, the black solid cell represents ‘1’, and there is only one black solid cell in one position index vector. In addition to the black solid cell R61, there are also 9999 hollow cells in R6, the hollow cell represents ‘0’, here, only a portion of hollow cells is shown.

The black solid cell in FIG. 3 corresponds to position of word(t) in R2, so the position index vector R6 contains position information of word(t) in the lexicon R1. R5 represents output vector of the class-based language model.

Next, referring to FIG. 3, output vector of the class-based language model is described by taking the output vector R5 of the class-based language model for example. In the following description, the output vector R5 of the class-based language model is referred to as output vector R5 for short.

Output vector R5 is also a multi-dimensional vector and represents probability output of the language model R4.

As stated above, when training the language model R4, classification is made in 315 POS classes.

The dimension of the output vector R5 corresponds to the classified result, which is a vector that has 315 dimensions, and position of each dimension represents some specific part of speech in the 315 POS classes, value of each dimension represents probability of some specific part of speech in the 315 POS classes.

Furthermore, in case that R4 is an n-gram language model, probability that the n^{th} word is certain part of speech can be calculated according to the part of speech of the preceding n−1 words.

In the present embodiment, as an example, the language model R4 is a 4-gram language model, so probability that the 4^{th} word (i.e., word(t+1)) is some part of speech in 315 POS classes can be calculated according to the part of speech of the preceding three words (i.e., word(t)word(t−1)word(t−2)), that is, probability that the next word of the word(t) is which part of speech can be calculated.

In FIG. 3, each cell in R5 represents one dimension, that is, each cell corresponds to some part of speech in the 315 POS classes, and value of each cell represents probability that the next word is some specific part of speech, which is above or equal to 0 and below or equal to 1, so it is shown in gray solid cell. Only a portion of dimensions is shown in FIG. 3.

The description is given above by taking that R4 is a 4-gram language model for example, in particular, in case that R4 is a 1-gram language model, in the output vector R5, value of a position corresponding to part of speech of current word(t) (that is, certain cell in R5) becomes 1, and positions of remaining cells are all 0.

After obtaining position index vector R6 corresponding to word(t) and output vector R5, the output vector R5 is incorporated into the position index vector R6, and the incorporated vector is taken as an input vector of the neural network language model to train the neural network language model, thereby obtaining neural network language model of R7.

Here, ‘incorporate’ means addition of dimension of the position index vector R6 and that of the output vector R5, in case that dimension of the position index vector R6 is 10000 and dimension of the output vector R5 is 315 as mentioned above, the incorporated vector becomes a vector whose dimension is 10315.

In the present embodiment, the incorporated 10315-dimensional vector contains position information of word(t) in the lexicon R1 and information of probability that word(t+1) is some part of speech in the R1 POS classes.

In the present embodiment, a vector of the class-based language model is added into input vector of the neural network language model as additional feature, which can improve performance of learning and prediction of word sequence probabilities of the neural network language model.

In addition, in the present embodiment, there are various classification criteria (e.g. part of speech, semantic and pragmatic information etc.), in one classification criteria there are different classification strategies (e.g. there are 100 POS classes or 315 POS classes for part of speech classification, etc.), and in one classification criteria there are also language models with different N-gram levels (e.g. 3-gram, 4-gram and etc.), and there are also many options for language model (e.g. ARPA language model, DNN language model, RNN language model and RF language model), thus, diversity of classification of words in a lexicon can be increased. Accordingly, diversity of trained class-based language model can also be increased, to obtain a plurality of neural network language models improved by taking scores of class-based language models as additional feature, and when those neural network language models are combined, recognition rate can be further improved and recognition performance can be enhanced.

Speech Recognition Method

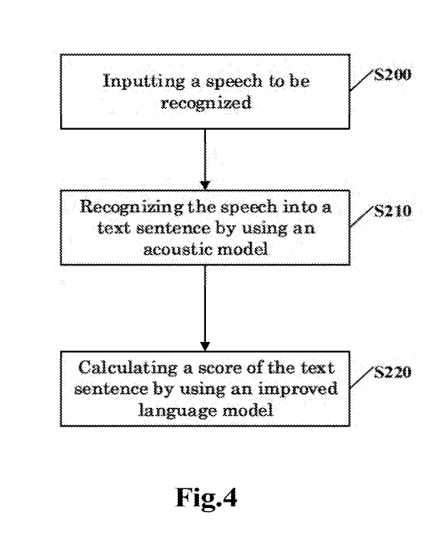

FIG. 4 is a flowchart of a speech recognition method of the invention under a same inventive concept. Next, the present embodiment will be described in conjunction with that figure. For those same parts as the above embodiments, the description of which will be properly omitted.

In the present embodiment, in S200, a speech to be recognized is input, then the method proceeds to S210.

In S210, the speech is recognized into a text sentence by using an acoustic model, then the method proceeds to S220.

In S220, a score of the text sentence is calculated by using a language model improved by the method of the above first embodiment.

Thus, since a neural network language model that improves performance of learning and prediction of word sequence probabilities is used, recognition rate of the speech recognition method can be improved.

In S220, scores may also be respectively calculated by using two or more language models, and a weighted average of the calculated scores is taken as the score of the text sentence.

Wherein, it is sufficient that at least one of the two or more language models is a language model improved by using the method of the above first embodiment, or all of the language models are the improved language model, or it may be the case that one part thereof is an improved language model, and the other part are various known language models such as ARPA language model.

Thus, neural network language model with different additional feature can be further combined, and recognition rate of the speech recognition method can be further improved.

As to the unproved language model used in S220, it is sufficient to use a neural network language model improved according to the above method for improving a neural network language model, the process of improvement has been described in detail in the method for improving a neural network language model, and detailed description of which will be omitted here.

An Apparatus for Improving a Neural Network Language Model of a Speech Recognition System

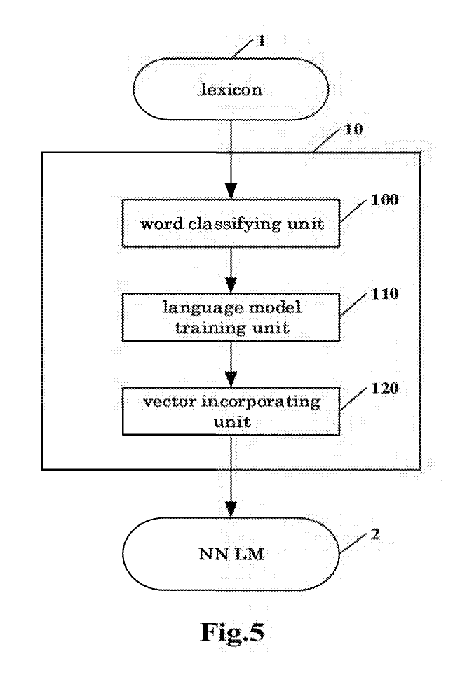

FIG. 5 is a block diagram of an apparatus for improving a neural network language model of a speech recognition system of the invention under a same inventive concept. Next, the present embodiment will be described in conjunction with that figure. For those same parts as the above embodiments, the description of which will be properly omitted.

Hereinafter, ‘apparatus for improving a neural network language model of a speech recognition system’ wall sometimes be referred to as ‘apparatus for improving a language model’ for short.

The present embodiment provides an apparatus 10 for improving a neural network language model of a speech recognition system, comprising: a word classifying unit 100 configured to classify words in a lexicon 1 of the speech recognition system; a language model training unit 110 configured to train a class-based language model based on the classified result; and a vector incorporating unit 120 configured to incorporate an output vector of the class-based language model into a position index vector of the neural network language model and use the incorporated vector as an input vector of the neural network language model 2.

As shown in FIG. 5, words in a lexicon of the speech recognition system are classified by the word classifying unit 100.

As to the method for classifying words in a lexicon of a speech recognition system used by the word classifying unit 100, description will be made with reference to the block diagram of FIG. 2.

In FIG. 2, P1 shows word1, word 2 . . . in the lexicon.

As shown in P2, as criteria for classifying words in a lexicon of a speech recognition system, part of speech, semantic and pragmatic information etc. may be listed, and the embodiment has no limitation thereto. In the present embodiment, the description is made by taking part of speech as an example.

There are also different classification strategies when classifying words in a lexicon by using a same classification criterion, for example, as shown by P3 in FIG. 2, when words in a lexicon are classified by taking part of speech as criterion, as in the present embodiment, there are classification that has 315 POS classes and classification that has 100 POS classes.

In the present embodiment, the description is made by taking the classification strategy that has 315 POS classes as an example.

When a strategy for classifying words in a lexicon has been determined, word1, word 2 . . . in P1 will be classified into POS1, POS2 . . . in P4 corresponding to the 315 POS classes, so as to finish classification of words in the lexicon.

In addition, the criterion for classifying words in a lexicon of a speech recognition system is not limited to the above listed criteria, and any criterion may correspond to different classification strategies.

Returning to FIG. 5, after words in a lexicon of the speech recognition system are classified by the word classifying unit 100, a class-based language model is trained by the language model training unit 110 based on the classified result.

Training a class-based language model by the language model training unit 110 based on the classified result is described in detail with reference to FIG. 2.

When a class-based language model is trained based on the classified result in P4, the class-based language model may be trained by different n-gram levels, for example, a 3-gram language model, a 4-gram language model may be trained, etc. Besides, as type of the trained language model, ARPA language model, DNN language model, RNN language model and RF (random field) language model may be listed, for example, or it may be other language model.

As shown in P5 of FIG. 2, in the present embodiment, a 4-gram ARPA language model is taken as an example and it is taken as the class-based language model.

Returning to FIG. 5, after a class-based language model is trained by the language model training unit 110 based on the classified result, an output vector of the class-based language model is incorporated into a position index vector of the neural network language model by the vector incorporating unit 120 and the incorporated vector is used as an input vector of the neural network language model 2.

Next, referring to the block diagram of FIG. 3, an example of the processing performed by the vector incorporating unit 120 will be described, and in FIG. 3, description is made by taking the position index vector corresponding to word(t) and the output vector of the class-based language model for example.

R1 represents a lexicon, and in the present embodiment the lexicon R1 contains, for example, 10000 words.

As shown by R2 and R3, the 10000 words ‘ . . . word(t−n+1) . . . word(t−1)word(t)word(t+1) . . . ’ in the lexicon are classified in 315 POS classes, and ‘ . . . POS(t−n+1) . . . POS(t−1)POS(t)POS(t+1) . . . ’ in corresponding R3 are obtained.

The 4-gram ARPA language model in R4 is the class-based language model trained by the language model training unit 110, which takes 315 POS classes as the classification strategy. R6 represents the position index vector.

Next, referring to FIG. 3, the position index vector is described by taking the position index vector R6 for example.

A position index vector is feature of each word of a conventional neural network language model, its dimension is the same as the number of words in a lexicon, corresponding word position element, is labeled as “1” and others are labeled as “0” in the lexicon. Thus, the position index vector contains position information of words in the lexicon.

In the present embodiment, the lexicon R1 contains 10000 words, so dimension of the position index vector R6 is 10000, in FIG. 3, each cell in R6 represents one dimension, and only a portion of dimensions is shown in FIG. 3.

The black solid cell R61 in the position index vector R6 corresponds to position of word in the lexicon, the black solid cell represents ‘1’, and there is only one black solid cell in one position index vector. In addition to the black solid ceil R61, there are also 9999 hollow cells in R6, the hollow cell represents ‘0’, here, only a portion of hollow cells is shown.

The black solid cell in FIG. 3 corresponds to position of word(t) in R2, so the position index vector R6 contains position information of word(t) in the lexicon R1. R5 represents output vector of the class-based language model.

Next, referring to FIG. 3, output vector of the class-based language model is described by taking the output vector R5 of the class-based language model for example. In the following description, the output vector R5 of the class-based language model is referred to as output vector R5 for short.

Output vector R5 is also a multi-dimensional vector and represents probability output of the language model R4.

As stated above, when training the language model R4, classification is made in 315 POS classes.

The dimension of the output vector R5 corresponds to the classified result, which is a vector that has 315 dimensions, and position of each dimension represents some specific part of speech in the 315 POS classes, value of each dimension represents probability of some specific part of speech in the 315 POS classes.

Furthermore, in case that R4 is an n-gram language model, probability that the n^{th} word is certain part of speech can be calculated according to the part of speech of the preceding n−1 words.

In the present embodiment, as an example, the language model R4 is a 4-gram language model, so probability that the 4^{th} word (i.e., word(t+1)) is some part of speech in 315 POS classes can be calculated according to the part of speech of the preceding three words (i.e., word(t)word(t−1)word(t−2)), that is, probability that the next word of the word(t) is which part of speech can be calculated.

In FIG. 3, each cell in R5 represents one dimension, that is, each cell corresponds to some part of speech in the 315 POS classes, and value of each cell represents probability that the next word is some specific part of speech, which is above or equal to 0 and below or equal to 1, so it is shown in gray solid cell. Only a portion of dimensions is shown in FIG. 3.

The description is given above by taking that R4 is a 4-gram language model for example, in particular, in case that R4 is a 1-gram language model, in the output vector R5, value of a position corresponding to part of speech of current word(t) (that is, certain cell in R5) becomes 1, and positions of remaining cells are all 0.

After obtaining position index vector R6 corresponding to word(t) and output vector R5, the output vector R5 is incorporated into the position index vector R6, and the incorporated vector is taken as an input vector of the neural network language model to train the neural network language model, thereby obtaining neural network language model of R7.

Here, ‘incorporate’ means addition of dimension of the position index vector R6 and that of the output vector R5, in case that dimension of the position index vector R6 is 10000 and dimension of the output vector R5 is 315 as mentioned above, the incorporated vector becomes a vector whose dimension is 10315.

In the present embodiment, the incorporated 10315-dimensional vector contains position information of word(t) in the lexicon R1 and information of probability that word(t+1) is some part of speech in the 315 POS classes.

In the present embodiment, according to the apparatus 10 for improving a language model, a vector of the class-based language model is added into input vector of the neural network language model as additional feature, which can improve performance of learning and prediction of word sequence probabilities of the neural network language model.

In addition, in the present embodiment, according to the apparatus 10 tor improving a language model, there are various clarification criteria (e.g. part of speech, semantic and pragmatic information etc.), in one classification criteria there are different classification strategies (e.g. there are 100 POS classes or 315 POS classes for part of speech classification, etc.). and in one classification criteria there are also language models with different N-gram levels ( e.g. 3-gram, 4-gram and etc.) and there are also many options for language model (e.g. ARPA language model, DNN language model, RNN language model and RF language model), thus, diversity of classification of words in a lexicon can be increased. Accordingly, diversity of trained class-based language model can also be increased to obtain a plurality of neural network language models improved by taking scores of class-based language models as additional feature, and when these neural network language models are combined, recognition rate can be further improved and recognition performance can be enhanced.

Speech Recognition Apparatus

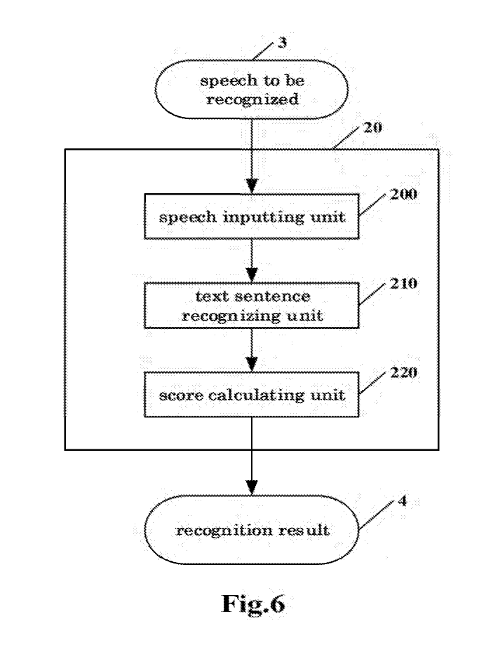

FIG. 6 is a block diagram of a speech recognition apparatus of the invention under a same inventive concept. Next, the present embodiment will be described in conjunction with that figure. For those same parts as the above embodiments, the description of which will be properly omitted.

The present embodiment provides a speech recognition apparatus 20, comprising: a speech inputting unit 200 configured to input a speech to be recognized 3; a text sentence recognizing unit 210 configured to recognize the speech into a text sentence by using an acoustic model; and a score calculating unit 220 configured to calculate a score of the text sentence by using a language model; the language model includes a language model improved by using the apparatus for improving a neural network language model of a speech recognition system.

In this embodiment, a speech to be recognized is input by the speech inputting unit 200, then the speech is recognized into a text sentence by the text sentence recognizing unit 210 by using an acoustic model.

After the text sentence is recognized by the text sentence recognizing unit 210, a score of the text sentence is calculated by the score calculating unit 220 by using a language model improved by the above method for improving a language model, and recognition result is generated based the score.

Thus, according to the speech recognition apparatus 20 of the present embodiment, since a neural network language model that improves performance of learning and prediction of word sequence probabilities is used, recognition rate of the speech recognition method can be improved.

In addition, scores may also be respectively calculated by the score calculating unit 220 by using two or more language models, and a weighted average of the calculated scores is taken as the score of the text sentence.

Wherein, it is sufficient that at least one of the two or more language models is the above improved language model, or all of the language models are the improved language model, or it may be the case that one part thereof is an improved language model, and the other part are various known language models such as ARPA language model.

Thus, neural network language model with different additional feature can be further combined, and recognition rate of the speech recognition method can be further improved.

As to the improved language model used by the score calculating unit 220, it is sufficient to use a neural network language model improved according to the above method for improving a neural network language model, the process of improvement has been described in detail in the method for improving a neural network language model, and detailed description of which will be omitted here.

Although a method for improving a neural network language model of a speech recognition system, an apparatus for improving a neural network language model of a speech recognition system, a speech recognition method and a speech recognition apparatus of the present invention have been described in detail through some exemplary embodiments, the above embodiments are not to be exhaustive, and various variations and modifications may be made by those skilled in the art within spirit and scope of the present invention. Therefore, the present invention is not limited to these embodiments, and the scope of which is only defined in the accompany claims.

1: An apparatus for improving a neural network language model of a speech recognition system, comprising:
a word classifying unit that classifies words in a lexicon of the speech recognition system;
a language model training unit that trains a class-based language model based on the classified result; and
a vector incorporating unit that incorporates an output vector of the class-based language model into a position index vector of the neural network language model and use the incorporated vector as an input vector of the neural network language model.

2: The apparatus for improving a neural network language model according to claim 1, wherein
the word classifying unit classifies the words in the lexicon based on a pre-set criterion.

3: The apparatus for improving a neural network language model according to claim 2, wherein
the pre-set criterion comprises a part of speech, semantic and pragmatic information.

4: The apparatus for improving a neural network language model according to claim 3, wherein
the word classifying unit classifies the words in the lexicon by using a pre-set classification strategy based on a part of speech.

5: The apparatus for improving a neural network language model according to claim 1, wherein
the language model training unit trains the class-based language model by a pre-set N-gram level.

6: The apparatus for improving a neural network language model according to claim 1, wherein
the class-based language model comprises ARPA language model NN language model and RF language model.

7: The apparatus for improving a neural network language model according to claim 6, wherein
the NN language model comprises DNN language model and RNN language model.

8: A speech recognition apparatus, comprising:
a speech inputting unit that inputs a speech to be recognized;
a text sentence recognizing unit that recognizes the speech into a text sentence by using an acoustic model; and
a score calculating unit calculates a score of the text sentence by using a language model;
the language model includes a language model improved by using the apparatus according to claim 1.

9: A method for improving a neural network language model of a speech recognition system, comprising:
classifying words in a lexicon of die speech recognition system;
training a class-based language model based on the classified result; and
incorporating an output vector of the class-based language model into a position index vector of the neural network language model and using the incorporated vector as an input vector of the neural network language model.

10: A speech recognition method, comprising:
inputting a speech to be recognized;
recognizing the speech into a text sentence by using an acoustic model; and
calculating a score of the text sentence by using a language model;
the language model includes a language model improved by using the method according to claim 9.
